(19) United States
(12) Patent Application Publication
(10) Pub. No.: US 2003/0232125 A1
(43) Pub. Date: Dec. 18, 2003

(54) Apparatus and method for preselection of a coating program in powder coating

(76) Inventors: Daniel Ziwica, Stachenweg (CH); Christoph Rhiner, Erienstrass (CH)

Correspondence Address: John M. Haurykiewicz, FAEGRE & BENSON LLP, 2200 Wells Fargo Center, 90 South Seventh Street, Minneapolis, MN, 55402-3901, US

(21) Appl. No.: 10/462,457

(22) Filed: Jun. 16, 2003

(30) Foreign Application Priority Data
Jun. 17, 2002 (DE) 20209377.8

(51) Int. Cl. B05D 1/04

(52) U.S. Cl. 427/8; 427/475; 427/180; 700/1; 118/696

(57) ABSTRACT

A method and an apparatus for preselection of a coating program in powder coating by means of a coating gun comprises a control apparatus, wherein in said apparatus at least two selector keys are provided at the control apparatus and/or the coating gun for selecting one of at least two different coating techniques and wherein said method allows the user to select one of at least two different coating techniques, e.g. “Corona Coating” or “Tribo Coating”, respectively, by pressing a respective key provided at a control apparatus or at said coating gun.

### BACKGROUND OF THE INVENTION

The invention relates to an apparatus and a method for preselection of a coating program or formulation in powder coating by means of a coating gun, preferably a hand-held coating gun, comprising a control apparatus which may be arranged separate from the coating gun or integrated in the same.

In powder coating, especially if done manually, a worker using a known apparatus, is not in a position to adjust the coating parameters at least halfway properly in response to the geometry and material of the various workpieces to be coated, until after he has gathered an extensive amount of practical experience.

The parameters to be adjusted comprise in particular the electrode voltage, the electrode current or spray current, the electrode current/voltage characteristic, the conveying air amount, the atomizing air amount, the tribo air amount, the total air amount, and the amount of powder, as well as the coating time period.

Among them the electrostatic parameters, like electrode voltage and electrode current are especially difficult to select.

### OBJECT OF THE INVENTION

It is, therefore, an object of the invention to provide an apparatus which will make it much easier for a user to select a program which is the respective most efficient one or a suitable formulation, for the most varied coating tasks.

The object is met, according to the invention, with an apparatus for preselection of a program or formulation in powder coating by means of a coating gun, comprising a control apparatus, characterized in that at least two selector keys are provided at the control apparatus and/or the coating gun for selecting two different coating techniques.

These coating techniques, preferably, are “corona coating” or “tribo coating”, both familiar to those skilled in the art so that they need not be described here in greater detail.

Advantageously, the selector keys permit further coating techniques to be selected alternatively, such as “metallic coating” or “individual coating”.

The selector keys may be designed so as to allow varying each coating technique selected as described above. Advantageous examples hereof are as follows. The selector keys 12-15 permit a selection to be made of a plurality of current/voltage characteristics 30, 32, 34, especially of a characteristic 32 which is flatter by 20% to 40% or a characteristic 34 which is flatter by 60% to 80%, compared with a standard characteristic 30. The selector keys 12-15 permit allowance to be made for different workpiece geometries. In addition, a selector key 14 may provide for consideration of an option of “re-coating”.

According to another modification of the invention, the magnitude of the essential parameters in powder coating may be adjusted variably by means of the selector keys in the sense of optimization, depending on the coating technique selected and the respective additional specification selected, as described in the above examples.

### BRIEF DESCRIPTION OF THE DRAWINGS

The invention will be described further, by way of example, with reference to the accompanying drawings, in which:

FIG. 1 is a diagrammatic view of an installation for manual powder coating according to the invention.

FIG. 2 shows a first display level of a screen of a control apparatus belonging to the installation illustrated in FIG. 1 and also indicating associated selector keys.

FIG. 3a illustrates a first variant of a second display level of the screen.

FIG. 3b illustrates a second variant of a second display level of the screen.

FIG. 3c illustrates a third variant of a second display level of the screen.

FIG. 3d illustrates a fourth variant of a second display level of the screen.

FIG. 4 is a diagram illustrating variants of the spray current/electrode voltage characteristic which are selectable according to the invention.

### DETAILED DESCRIPTION

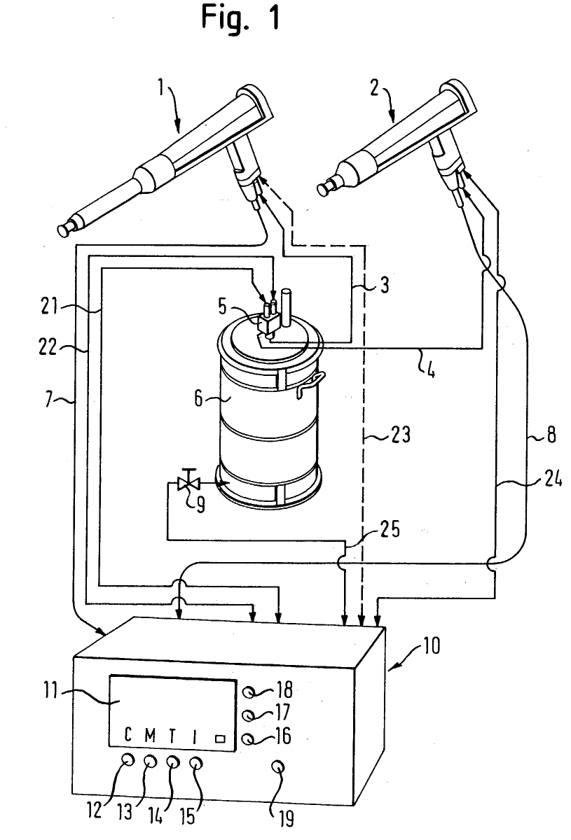

As illustrated in the diagrammatic presentation of FIG. 1, two hand-held coating guns for alternative usage are provided, namely a tribo spray gun 1 and a corona spray gun 2, both being of known design. Delivery hoses 3, 4 for a powder-air mixture connect these spray guns 1, 2 to a conventional injector 5 which communicates with the interior of a powder reservoir 6.

The two spray guns 1, 2, furthermore, are connected by electrical cables 7, 8 to a control apparatus 10 comprising a screen 1 1 and selector keys 12 to 18 for selection of a coating technique, including a program or formulation of the particular coating technique selected, and a display level.

Moreover, the control apparatus 10 is connected to the injector 5 by a dosing air conduit 21 and a conveying air conduit 22.

Finally, the control apparatus 10 is connected to the tribo spray gun 1 by a tribo air conduit 23 and, alternatively, to the corona spray gun 2 by an atomizing air conduit 24.

Reference numeral 25 designates a fluidizing air conduit which passes from the control apparatus 10 through a throttle 9 to the bottom of the powder reservoir 6 to fluidize the powder there.

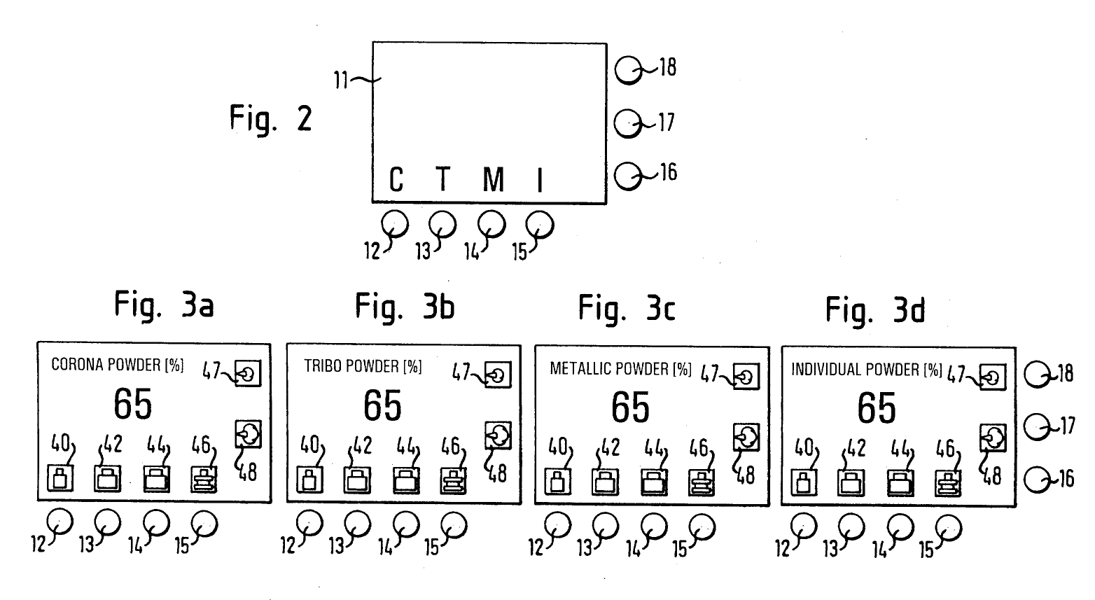

FIG. 2 the screen 11 is illustrated in a situation where a first display level is to be seen the screen 11.

The capital letters in the screen 11 are assigned to the selector keys 12 to 15 underneath them and have the following meaning:

| | |
|---|---|
| C | corona coating |
| T | tribo coating |
| M | metallic coating |
| I | individual coating. |

The selector keys 16, 17, and 18 shown next to the screen 11 at the right hand side thereof in FIGS. 1, 2, and 3d have the following meaning:

| | |
|---|---|
| 16 | reset the display level |
| 17 | small powder cloud (little powder) |
| 18 | big powder cloud (much powder) |

The button marked 19 in FIG. 1 serves for switching on/off the control apparatus 10.

When the control apparatus 10 is switched on and the first display level shown, actuation of the buttons 12 to 15 will result in one of the presentations according to FIGS. 3a to 3d to be shown in a second display level of the screen 11. For example, when pressing selector key 12, the presentation of FIG. 3a will appear, indicating that the “corona coating” technique was selected, with corona powder at a percentage quantity of powder of 65%.

With the second display level being shown on the screen, renewed pressing of any of the selector keys 12 to 15 permits the following coating parameters to be changed:

selector key 12—small workpiece (little powder)

selector key 13—big workpiece (much powder)

selector key 14—re-coating

selector key 15—deep workpiece.

Pressing of selector key 16 causes switchover of the display levels, i.e. from the second display level in FIGS. 3a to 3d back to the first display level according to FIG. 2.

Selective pressing of either one of keys 17,18 permits the choice of working with just a little powder (small powder cloud) or with a lot of powder (big powder cloud).

In addition to displaying the coating technique selected and the percentage content of powder in the powder-air mixture, the second display level of FIGS. 3a to 3d includes symbols which are associated with the selector keys and indicate the respective parameters chosen in the second display level. Their meaning is as follows:

| | |
|---|---|
| small rectangle | 40 - small workpiece |
| big rectangle | 42 - big workpiece |
| 2x | 44 - re-coating |
| rectangular profile | 46 - deep workpiece |
| little powder | 47 - small powder cloud |
| much powder | 48 - big powder cloud. |

Having chosen and mechanically connected the desired spray gun 1 or 2 and having selected the desired coating technique C, T, M, I in the first display level by having pressed the respective selector key, the user will obtain automatic adjustment, in the second display level, of the program or formulation matching the selected coating technique, by again actuating the previously pressed selector key. Any further adjustment can be dispensed with.

On the whole, therefore, sixteen programs or formulations are available, allowing the user to set specific parameter data for the items listed below, simply by pressing the respective key:

electrode voltage

maximum spray current

electrode current/voltage characteristic

volume of conveying air for powder delivery

volume (amount) of atomizing air

total air volume (amount)

volume (amount) of tribo air in case of tribo charging.

Additionally, the user can vary the powder quantity by either pressing the respective selector key several times or holding the key pressed until the display indicates the desired increase which, of course, is also implemented at the gun.

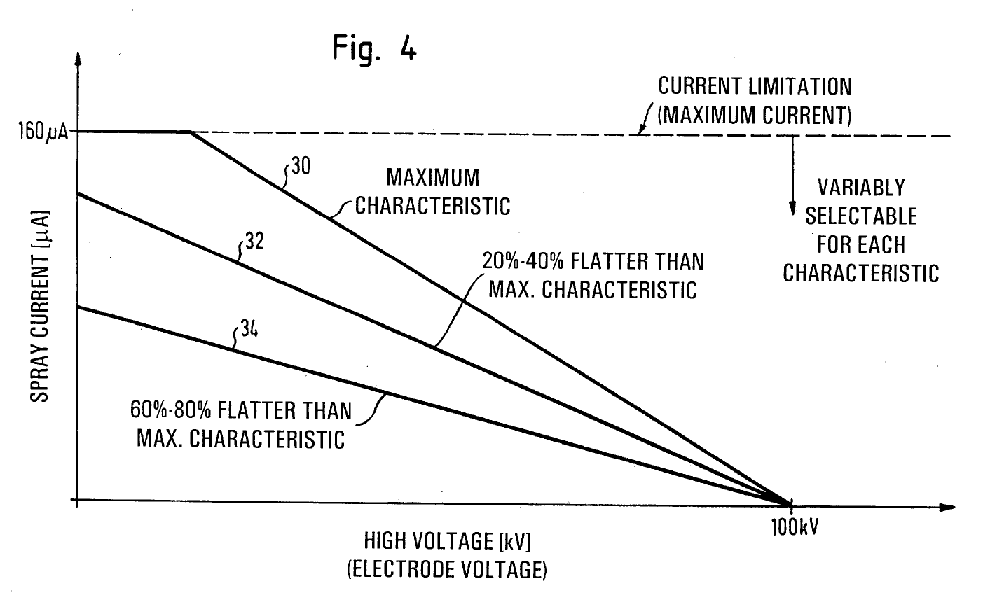

The diagram of FIG. 4 illustrates three variants of the electrode current/electrode voltage characteristic, reference numeral 30 designating the maximum characteristic, 32 designating a characteristic which is flatter by between 20% and 40% and 34 designating a characteristic which is still flatter by between 60% and 80% than the maximum characteristic. The maximum characteristic is cut at an upper horizontal level of maximum current of 160 μA. This maximum current may be selected variably for each characteristic.

The features disclosed in the specification above, in the figures and claims may be significant to implementing the invention, both individually and in any ombination.

What is claimed is:

1. An apparatus for preselection of a coating program in powder coating of workpieces by means of a coating gun (1,2), comprising a control apparatus (10), wherein at least two selector keys (12-15) are provided at the control apparatus (10) and/or the coating gun for selecting one of at least two different coating techniques (C, T, M, I).

2. The apparatus as claimed in claim 1, wherein the coating techniques of “Corona coating” (C) and “Tribo coating” (T) are assigned to the two selector keys (12, 13), respectively.

3. The apparatus as claimed in claim 1, wherein a further selector key (14) is provided for selecting a further coating technique of “Metallic coating” (M).

4. The apparatus as claimed in one of claims 1, wherein a further selector key (15) is provided for selecting still a further coating technique of “Individual coating” (I).

5. The apparatus as claimed in claim 1, wherein further selector keys (16-18) are provided for varying each of the selected coating techniques (C, T, M, I).

6. The apparatus as claimed in claim 5, wherein the selector keys (12-15) permit a selection to be made of a plurality of current/voltage characteristics (30, 32, 34), especially of a characteristic (32) which is flatter by 20% to 40% or a characteristic (34) which is flatter by 60% to 80%, compared with a standard characteristic (30).

7. The apparatus as claimed in claim 5, wherein the selector keys (12-15) permit allowance to be made for different workpiece geometries.

8. The apparatus as claimed in claim 5, wherein a selector key (14) provides for consideration of an option of “re-coating”.

9. The apparatus as claimed in claim 5, wherein the magnitude of the essential parameters in powder coating is variable in the sense of optimization, depending on the coating technique (C, T, M, I) selected as well as the additional specification selected in accordance with any one of claims 5 to 8.

10. The apparatus as claimed in claim 9, wherein said parameters comprise the electrode voltage, the maximum current, the electrode current/voltage characteristic, the amount of conveying air, the amount of atomizing air, the total air amount, the amount of tribo air, and the amount of powder.

11. The apparatus as claimed in claim 1, wherein a program for selection of different workpiece geometries is provided on another display level, subordinate to the selected coating technique program.

12. A method for selection of a coating program in powder coating of workpieces, said selection comprising pressing of one of at least two keys, each being assigned to one of at least two different coating techniques.

13. The method of claim 12, wherein the coating techniques of “Corona coating” (C) and “Tribo coating” (T) are assigned to the two selector keys (12, 13), respectively.

14. The method of claim 12, wherein a further selector key (14) is provided for selecting a further coating-technique of “Metallic coating” (M).

15. The method of claim 12, wherein a further selector key (15) is provided for selecting still a further coating technique of “Individual coating” (I).

16. The method of claim 12, wherein further selector keys (16-18) are provided for varying each of the selected coating techniques (C, T, M, I).

17. The method of claim 16, wherein the selector keys (12-15) permit a selection to be made of a plurality of current/voltage characteristics (30, 32, 34), especially of a characteristic (32) which is flatter by 20% to 40% or a characteristic (34) which is flatter by 60% to 80%, compared with a standard characteristic (30).

18. The method of claim 16, wherein the selector keys (12-15) permit allowance to be made for different workpiece geometries.

19. The method of claim 16, wherein a selector key (14) provides for consideration of an option of “re-coating”.

20. The method of claim 16, wherein the magnitude of the essential parameters in powder coating is variable in the sense of optimization, depending on the coating technique (C, T, M, I) selected as well as the additional specification selected in accordance with any one of claims 16 to 19.

21. The method of claim 20, wherein said parameters comprise the electrode voltage, the maximum current, the electrode current/voltage characteristic, the amount of conveying air, the amount of atomizing air, the total air amount, the amount of tribo air, and the amount of powder.

22. The method of claim 12, wherein a program for selection of different workpiece geometries is provided on another display level, subordinate to the selected coating technique program.
